(19) United States
(12) Patent Application Publication
(10) Pub. No.: US 2020/0249761 A1
(43) Pub. Date: Aug. 6, 2020

(54) METHOD AND DEVICE FOR PROVIDING A PROGRAMMABLE CLICK SENSATION ON A TOUCH SURFACE

(71) Applicant: NORTHWESTERN UNIVERSITY, Evanston, IL (US)

(72) Inventors: J. Edward Colgate, Evanston, IL (US); Michael A. Peshkin, Evanston, IL (US); Heng XU, Evanston, IL (US)

(21) Appl. No.: 16/782,644

(22) Filed: Feb. 5, 2020

Related U.S. Application Data
(60) Provisional application No. 62/801,470, filed on Feb. 5, 2019.

(51) Int. Cl. G06F 3/01; G06F 3/041

(52) U.S. Cl. CPC G06F 3/016; G06F 3/0412

(57) ABSTRACT

A device for implementing a button click sensation on a touch surface without visually, audibly, or tactilely apparent motion of the surface is disclosed. The device includes a touch surface, a lateral vibration actuator configured to produce lateral vibrations of the touch surface, a friction controller configured to modulate a friction force between the touch surface and one or more appendages, and a touch sensing device configured to measure a location of a plurality of appendages on the touch surface. The device includes a control device configured to synchronize the friction force between the touch surface and at least one appendage of the plurality of appendages to the lateral vibrations produced by the lateral vibration actuator. The control device also applies a lateral force to the at least one appendage to emulate the sensation of a button click when the at least one appendage applies a pressing force to the touch surface that exceeds a threshold level.

### RELATED APPLICATIONS

This application claims benefit of and priority to U.S. Provisional Patent Application No. 62/801,470, filed Feb. 5, 2019. The '470 provisional application is incorporated herein by reference in its entirety.

### STATEMENT OF U.S. GOVERNMENT RIGHTS

At least one of the inventions was made with government support under Grant No. IIS-0964075 awarded by the National Science Foundation. The government has certain rights in that invention.

### INTRODUCTION

In one aspect, the present inventions are directed to touch user interfaces having surface haptic devices (SHD), and more particularly to touch user interfaces that are configurable to provide a localized, programmable button, switch and/or key click, snap and/or clack sensation to a user (e.g., via touch or touch and sound) to simulate, for example, the pressing, engaging and/or clicking of a button, switch and/or key (e.g., a key on a keyboard or keypad).

In one embodiment, the present inventions are directed to a user interface device for implementing a button, switch and/or key click, snap and/or clack sensation on a touch surface of a user interface without visual, audible, or tactile apparent motion of the surface (e.g., a touch pad or touch screen) to provide the user the sensation of pressing, engaging and/or clicking of a button, switch and/or key without actually or physically depressing, engaging and/or clicking of the button, switch and/or key. The user interface device, in one embodiment, includes a touch surface of, for example, a touch pad or touch screen (wherein one or more appendages (e.g., one or more fingers) of the user may engage), a lateral vibration actuator that is configured to generate minute lateral vibrations of the touch surface, and control circuitry, including a friction controller, that is configured to adjust or modulate a friction force between the touch surface and an appendage of a user when/while in contact with the touch surface. Here, the adjustment or modulation of the friction force is localized to the appendage. The user interface device of this embodiment also includes touch sensing circuitry that is configured to detect, measure and/or determine a location the appendage on the touch surface (e.g., a surface of a touch pad or touch screen). In response thereto, the control circuitry is configured to:
(a) synchronize the friction force (and/or modulation thereof) between the touch surface and the appendage to the lateral vibrations generated by the lateral vibration actuator to provide, for example, a force (e.g., an average force) on the appendage—wherein the magnitude and direction of the force is modifiable and/or controllable, and
(b) apply a lateral force to the appendage of the user to provide the user a sensation of a pressing, engaging and/or clicking of a button, switch and/or key in response to the user applying a sufficient pressing force (e.g., a pressing force that meets or exceeds a threshold level) to the touch surface (e.g., a surface of a touch pad or touch screen) via the appendage.

In one embodiment, the user interface device includes one or more normal force sensors configured to detect, sense and/or measure a pressing force, for example, by the appendage of the user. Here, a pressing force is a force that is applied to the touch surface wherein the force includes a component that is in a direction which is out-of-plane, normal and/or perpendicular to the touch surface or the portion of the touch surface that is engaged by the appendage of the user. The one or more normal force sensors provide signals to force detection circuitry which determines whether the detected, sensed and/or measured pressing force meets or exceeds a threshold. Where the pressing force meets or exceeds a threshold, the control circuitry (e.g., the friction controller), which is coupled to the force detection circuitry, adjusts or modulates the friction force of/on the touch surface in a region that is localized to the appendage of the user. The modulation or adjustment of the friction force, together with lateral vibration of the touch surface (e.g., via lateral vibration actuators), generate and/or apply a lateral force to the appendage of the user to provide the user a sensation of a pressing, engaging and/or clicking of a button, switch and/or key in response to the user applying a sufficient pressing force to the touch screen via the appendage.

In addition thereto, or in lieu thereof, the user interface device may include pressure detection circuitry to detect, sense and/or measure a distributed pressure on, across and/or applied to the touch surface, via the appendage of the user, of the interface device to measure and/or detect a pressing force. Here, the pressure detection circuitry may detect, sense and/or measure a distributed pressure on or across a portion of the touch surface (e.g., a portion of the touch surface that is localized to or about the portion of the touch surface engaged by the appendage) via a pressing force that is applied by the appendage of the user to the touch surface in a direction that is out-of-plane, normal and/or perpendicular to the touch surface (e.g., the portion of the touch surface that is engaged by the appendage).

In one embodiment, the user interface device may identify and/or detect a plurality of appendages of the user that are on or engaging the touch surface (e.g., two or more fingers of the user)—for example, the touch sensing circuitry may identify, detect, measure and/or determine the plurality of appendages. The control circuitry, using data from the touch sensing circuitry, may monitor the plurality of the appendages to determine whether one or more of the appendages generates a pressing force that the force detection circuitry and/or the pressure detection circuitry determines meets or exceeds a threshold (or one or more thresholds). Where the pressing force meets or exceeds a threshold, the control circuitry (e.g., the friction controller) adjusts or modulates the friction force of/on the touch surface in a region that is localized to the appendage of the user (e.g., the pointer finger or thumb) that generated or provided the pressing force. The modulation or adjustment of the friction force, together with lateral vibration of the touch surface (e.g., via lateral vibration actuators), generate and/or apply a lateral force to that particular appendage of the user (and not all of the appendages that are on or engaging the touch surface) to provide the user a sensation, via that particular appendage, of a pressing, engaging and/or clicking of a button, switch and/or key in response to the user applying a sufficient pressing force to the touch screen.

Notably, in one embodiment, where the control circuitry, using data from the touch sensing circuitry, determines more than one of the appendages generates a pressing force that meets or exceeds a threshold (or one or more thresholds), the control circuitry (e.g., the friction controller) may adjust or modulate the friction force of/on the touch surface in a region that is localized to the particular appendages of the user (e.g., the pointer and index fingers) that generated or provided the pressing force. Here, the modulation or adjustment of the friction force, together with lateral vibration of the touch surface (e.g., via lateral vibration actuators), generate and/or apply a lateral force to those particular appendages of the user (which may not be all of the appendages that are on or engaging the touch surface) to provide the user a sensation, via those particular appendages, of a pressing, engaging and/or clicking of a button, switch and/or key in response to the user applying a sufficient pressing force to the touch screen.

In a second aspect, the disclosure presents a method for implementing a button, switch and/or key click, snap and/or clack sensation on a touch surface without visually, audibly, or tactilely apparent motion of the surface, the method including producing lateral vibrations to a touch surface of a user interface device and modulating a friction force between the touch surface and a first appendage of a user when the first appendage is in contact with the touch surface, wherein the friction force is localized to the first appendage (i.e., a region on the touch surface that is local to the first appendage). The method further includes determining or measuring a location of one or more appendages of the user (including the first appendage) disposed on or in contact with the touch surface and synchronizing the friction force between the touch surface and the first appendage to the lateral vibrations produced by the lateral vibration actuator such that an force (e.g., average force) on the appendage is produced and the magnitude and direction of the force is controlled. In addition, the method includes applying a lateral force to the first appendage to emulate the sensation of a button, switch and/or key click, snap and/or clack when the first appendage applies a pressing force to the touch surface that exceeds a threshold level. The method also may include measuring the pressing force applied by the appendage to the touch screen.

It will be appreciated that for touch interfaces associated with the aforementioned aspects, the location and the feel of the click, snap and/or clack may be programmable (e.g., fully) to support different software-defined interfaces, and may be localized to support true touch typing in which multiple fingers may rest on the surface. According to certain embodiment, however, only a selected finger or fingers of the user (i.e., a subset of all fingers of the user) feel the aforementioned click, snap and/or clack sensation in accordance with the present inventions. Preferably, the circuitry, mechanism and techniques for generating, outputting and/or providing the click, snap and/or clack effect is compatible with modern manufacturing of touch surfaces and displays (e.g., touch pads and touch screens). For instance, in a preferred embodiment, the surface is unsegmented or not segmented into discrete buttons. Moreover, in a preferred embodiment, the surface does not include articulated, moving components.

Notably, this application describes and illustrates methods and circuitry, architectures and/or mechanisms for generating, outputting and/or providing localized click, snap and/or clack feedback on a touch surface to an appendage of a user by integrating (1), small amplitude (for example, about one to five microns peak-to-peak) in-plane (lateral) vibrations; (2), localized control of the friction between a fingertip and the surface; (3), multi-touch finger location sensing; (4), normal direction force/pressure sensing and/or distributed pressure sensing; and, (5) circuitry and techniques to generate, output and/or provide one or more predetermined lateral force profile on one or more selected fingers of a user in response to, for example, a sufficient normal pressure/force applied, input and/or generated thereby.

It is to be understood that both the foregoing general description and the following detailed description are exemplary and provided for purposes of explanation only, and are not restrictive of the subject matter claimed. Further features and objects of the present disclosure will become more fully apparent from the following detailed description, taken with the following drawings, and from the appended claims.

### BRIEF DESCRIPTION OF THE DRAWINGS

The present inventions may be implemented in connection with embodiments illustrated in the attached drawings. These drawings show different aspects of the present inventions and, where appropriate, reference numerals or names illustrating like structures, components, materials and/or elements in different figures are labeled similarly. It should be understood that the drawings are not to scale. While some details of a touch interface device, including, for example, details of fastening means and other plan and section views of the particular arrangements, have been omitted, such details have been omitted to avoid over complicating the drawings. This notwithstanding, such details are considered well within the comprehension of those of skill in the art in light of the present disclosure.

Moreover, there are many inventions described and illustrated herein. The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, certain permutations and combinations are not discussed and/or illustrated separately herein. Notably, an embodiment or implementation described herein as “exemplary” is not to be construed as ideal, preferred or advantageous, for example, over other embodiments or implementations; rather, it is intended reflect or indicate the embodiment(s) is/are “example” embodiment(s). Indeed, it should be understood that various combinations of the structures, components, materials and/or elements, other than those specifically shown, are contemplated and are within the scope of the present inventions.

FIG. 1A-1C illustrate, in block diagram form, exemplary user interface devices that produce, output and/or generate localized button, switch and/or key click, snap and/or clack sensation(s) to an appendage of a user (e.g., a finger), according to one or more aspects of the present inventions;

FIG. 1D illustrates, in a side or cross-sectional view, a portion of a user interface device (e.g., the display, touch surface, lateral vibration actuators, a friction controller, a normal force sensor) that produces, outputs and/or generates localized button, switch and/or key click, snap and/or clack sensations to an appendage (in the illustrative embodiment, a finger) of a user, according to at least one aspect of the inventions;

FIG. 1E illustrates, in a side or cross-sectional view and block diagram, a user interface device, according to at least one aspect of the inventions wherein the under interface device produces, outputs and/or generates localized button, switch and/or key click, snap and/or clack sensations to an appendage (in the illustrative embodiment, a finger) of a user;

FIG. 2 illustrates, in a flow-like block diagram form, a method of operation of the user interface device according to one or more aspects of the present inventions, wherein the method of operation, in one embodiment, produces, outputs and/or generates localized button click sensations to an appendage of a user, according to at least one aspect of the inventions;

FIG. 3 is a graphical depiction of lateral force measurements during button click rendering, according to one embodiment of the present inventions, via operation of at least one user interface device of the present inventions;

FIG. 4 is a graphical depiction of normal force measurements (e.g., via normal (out-of-plane) force sensor(s) and force detection circuitry) during button click rendering, according to one embodiment of the present inventions, via operation of at least one user interface device of the present inventions; and

FIG. 5 is a graphical depiction of the average range of pulse duration, at three different duty cycles, of the lateral force to be applied to a user in connection with button clicks.

Notably, reference herein to “one embodiment” or “an embodiment” (or the like) means that a particular feature, structure, or characteristic described in connection with the embodiment may be included, employed and/or incorporated in one, some or all of the embodiments of the present inventions. The usages or appearances of the phrase “in one embodiment” or “in another embodiment” (or the like) in the specification are not referring to the same embodiment, nor are separate or alternative embodiments necessarily mutually exclusive of one or more other embodiments, nor limited to a single exclusive embodiment. The same applies to the term “implementation.” The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, certain permutations and combinations are not discussed and/or illustrated separately herein.

Again, there are many inventions described and illustrated herein. The present inventions are neither limited to any single aspect nor embodiment thereof, nor to any combinations and/or permutations of such aspects and/or embodiments. Each of the aspects of the present inventions, and/or embodiments thereof, may be employed alone or in combination with one or more of the other aspects of the present inventions and/or embodiments thereof. For the sake of brevity, many of those combinations and permutations are not discussed separately herein.

### DETAILED DESCRIPTION

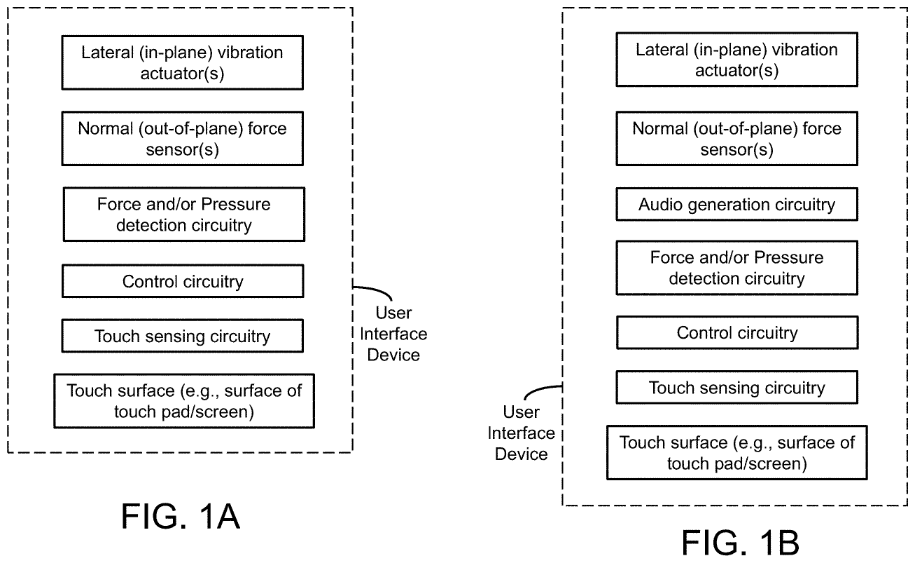

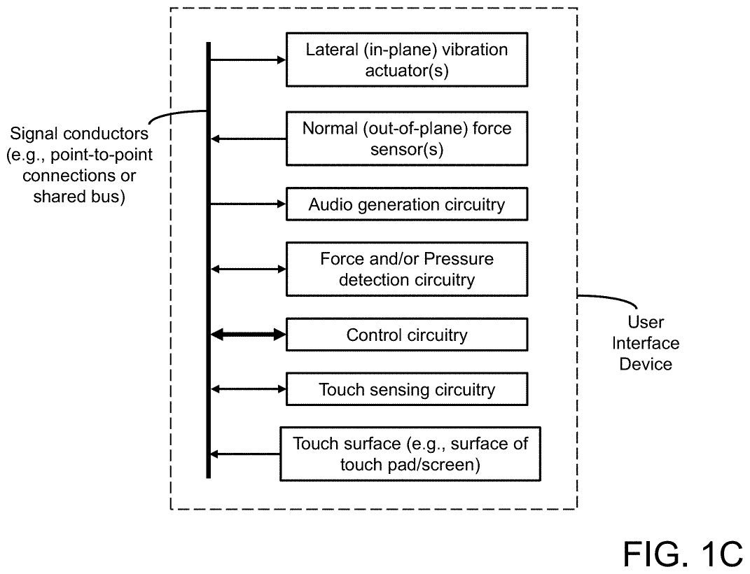

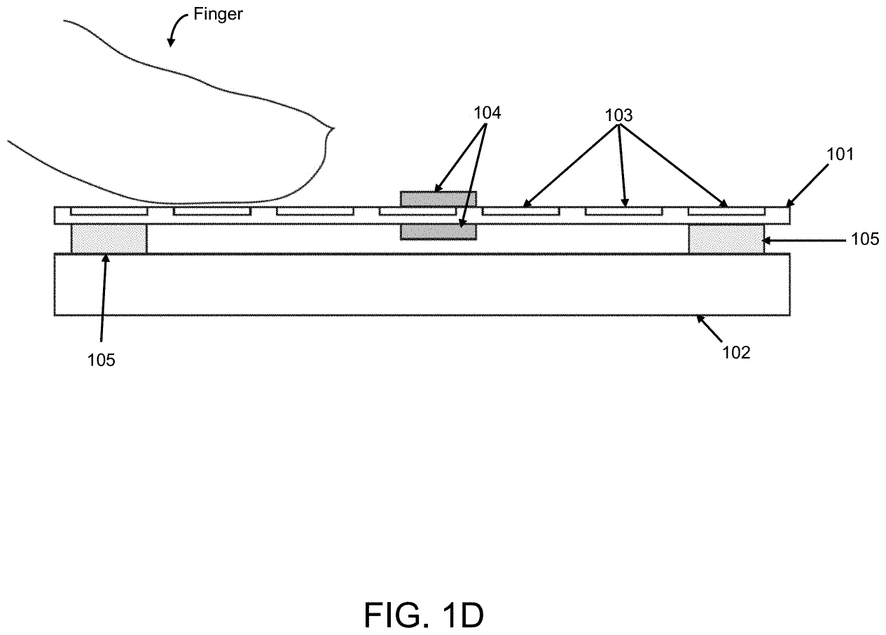

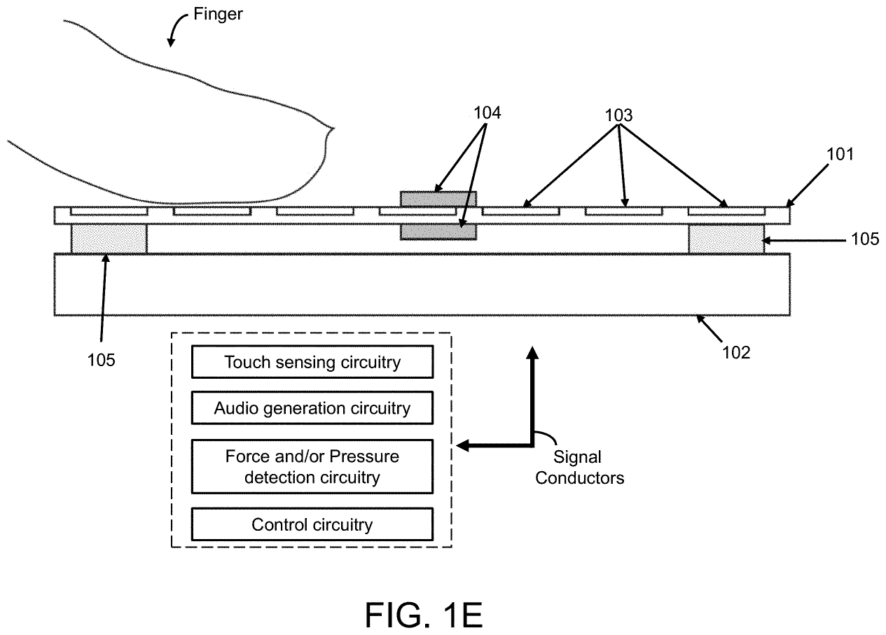

In one aspect, the present inventions are directed to a user interface device for implementing a button, switch and/or key click sensation on a touch surface of a user interface without visual, audible, or tactile apparent motion of the surface (e.g., a touch pad or touch screen) to provide the user the sensation of pressing, engaging and/or clicking of a button, switch and/or key without actually or physically pressing, engaging and/or clicking of the button, switch and/or key. With reference to FIGS. 1A-1C, the user interface device, in one embodiment, includes a touch surface of, for example, a touch pad or touch screen (wherein one or more appendages (e.g., one or more fingers) of the user may engage), a lateral vibration actuator that is configured to generate minute lateral vibrations of the touch surface, and control circuitry, including a friction controller, that is configured to adjust or modulate a friction force between the touch surface and an appendage of a user when/while in contact with the touch surface. Here, the adjustment or modulation of the friction force is localized to an appendage that is engaging or disposed on the touch surface. The user interface device of this embodiment also includes touch sensing circuitry that is configured to detect, measure and/or determine a location the appendage on the touch surface (e.g., a surface of a touch pad or touch screen). In response thereto, the control circuitry is configured to:
(a) synchronize the friction force (and/or modulation thereof) between the touch surface and the appendage to the lateral vibrations generated by the lateral vibration actuator to provide, for example, a force (e.g., an average force) on the appendage—wherein the magnitude and direction of the force is modifiable and/or controllable, and
(b) apply a lateral force to the appendage of the user to provide the user a sensation of a pressing, engaging and/or clicking of a button, switch and/or key in response to the user applying a sufficient pressing force (e.g., a pressing force that meets or exceeds a threshold level) to the touch surface (e.g., a surface of a touch pad or touch screen) via the appendage.

With reference to FIGS. 1A-1C, the user interface device may include one or more normal force sensors configured to detect, sense and/or measure a pressing force, for example, by the appendage of the user. Here, a pressing force is a force that is applied to the touch surface wherein the force includes a component that is in a direction which is out-of-plane, normal and/or perpendicular to the touch surface or the portion of the touch surface that is engaged by the appendage of the user. The one or more normal force sensors provide signals to force detection circuitry which determines whether the detected, sensed and/or measured pressing force meets or exceeds a threshold. Where the pressing force meets or exceeds a threshold, the control circuitry (e.g., the friction controller), which is coupled to the force detection circuitry, adjusts or modulates the friction force of/on the touch surface in a region that is localized to the appendage of the user. The modulation or adjustment of the friction force, together with lateral vibration of the touch surface (e.g., via lateral vibration actuators), generate and/or apply a lateral force to the appendage of the user which provides the user a sensation of a pressing, engaging and/or clicking of a button, switch and/or key in response to the user applying a sufficient pressing force to the touch surface via the appendage.

In addition thereto, or in lieu thereof, in one embodiment, the user interface device may include pressure detection circuitry to detect, sense and/or measure a distributed pressure on, across and/or applied to the touch surface, via one or more of the appendage of the user, of the interface device to measure and/or detect a pressing force. (See, e.g., FIGS. 1A-1C). Here, the pressure detection circuitry may detect, sense and/or measure a distributed pressure on or across a portion of the touch surface (e.g., a portion of the touch surface that is localized to or about the portion of the touch surface engaged by the appendage) via one or more pressing forces that is/are applied by the one or more appendages of the user to the touch surface in a direction that is out-of-plane, normal and/or perpendicular to the touch surface (e.g., the portion of the touch surface that is engaged by the appendage). The one or more appendages may touch the surface and the locations and pressures of will be detected and measured. The pressure detection circuitry may receive signals from one or more sensors (e.g., one or more normal force sensors) and determine whether the detected, sensed and/or measured distributed pressure on or across a portion of the touch surface (e.g., a portion of the touch surface that is localized to or about the portion of the touch surface engaged by the appendage) meets or exceeds one or more thresholds. Where the pressure distribution on or across a portion of the touch surface meets or exceeds a threshold, the control circuitry (e.g., the friction controller), which is coupled to the pressure detection circuitry, adjusts or modulates the friction force of/on the touch surface in a region that is localized to the appendage of the user. The modulation or adjustment of the friction force, together with lateral vibration of the touch surface (e.g., via lateral vibration actuators), generate and/or apply a lateral force to the appendage of the user which provides the user a sensation of a pressing, engaging and/or clicking a button, switch and/or key. Indeed, as discussed below, where more than one appendage of the user is on or engaging the touch surface, the control circuitry may instruct/control the circuitry of the user interface device to generate and apply the click, snap and/or clack sensation(s) to one or more selected appendages (i.e., appendage(s) that applied a sufficient pressing force to the touch surface) without generating and/or applying such sensation(s) to other appendages not applying a pressing force or a sufficient pressing force to the touch surface—albeit such other appendages may be disposed on or engaging the touch surface.

With reference to FIGS. 1B and 1C, in one embodiment, the user interface device may also include audio generation circuitry to generate audible feedback (e.g., a click sound to simulate the pressing and/or engaging of a button, switch and/or key) to, for example, the user, in response to detecting, sensing and/or measuring a sufficient pressing force (e.g., via the force detection circuitry and/or the pressure detection circuitry) to initiate or cause the control circuitry (e.g., the friction controller), via the lateral vibration actuators, to adjust or modulate the friction force of/on the touch surface in a region that is localized to the appendage of the user. In this way, the audio generated by the audio generation circuitry, supplements the feedback to the user—feedback that is in addition to the lateral force applied to the appendage of the user which provides the user a sensation of a pressing, engaging and/or clicking of a button, switch and/or key.

Notably, in one embodiment, the audio generation circuitry may enable or disable, for example, via a user interface, at start-up and/or in situ (i.e., during normal operation of the user interface device). In this way, the audio generation circuitry is one-time or more than one-time programmable by, for example, the user and/or device manufacturer. Moreover, the output level of and/or sound-type output by (e.g., a click, snap, clack and/or voice) the audio generation circuitry (i.e., volume level) may be programmable (e.g., at start-up and/or in situ—and one-time or more than one-time programmable) to enable/facilitate a desired, selected or suitable feedback signal to the user or another. The enabling/disabling of the audio generation circuitry, as well as the output level of and sound-type output by the audio generation circuitry, may be manually and/or audibly controlled/programmed (e.g., voice activated/controlled by the user).

Where a plurality of appendages of the user are on or engaging the touch surface (e.g., two or more fingers of the user), in one embodiment, the touch sensing circuitry of the user interface device may identify, detect, measure and/or determine the plurality of appendages. The control circuitry, using data from the touch sensing circuitry, may monitor a plurality of the appendages to determine whether one or more of the appendages generates a pressing force that the force detection circuitry and/or the pressure detection circuitry determines meets or exceeds a threshold (or one or more thresholds). Where the pressing force meets or exceeds a threshold, the control circuitry (e.g., the friction controller) adjusts or modulates the friction force of/on the touch surface in a region that is localized to the appendage of the user (e.g., the pointer finger or thumb) that input or provided the pressing force. The modulation or adjustment of the friction force, together with lateral vibration of the touch surface (e.g., via lateral vibration actuators), generate and/or apply a lateral force to that particular appendage of the user (and not all of the appendages that are on or engaging the touch surface) to provide the user a sensation, via that particular appendage, of a pressing, engaging and/or clicking of a button, switch and/or key in response to the user applying a sufficient pressing force to the touch surface.

Notably, in one embodiment, where the control circuitry, using data from the touch sensing circuitry, determines more than one of the appendages generates a pressing force that meets or exceeds a threshold (or one or more thresholds), the control circuitry (e.g., the friction controller) may adjust or modulate the friction force of/on the touch surface in a region that is localized to the particular appendages of the user (e.g., the pointer and index fingers) that generated or provided the pressing force. here, the modulation or adjustment of the friction force, together with lateral vibration of the touch surface (e.g., via lateral vibration actuators), generate and/or apply a lateral force to those particular appendages of the user (which may not be all of the appendages that are on or engaging the touch surface) to provide the user a sensation, via those particular appendages, of a pressing, engaging and/or clicking of a button, switch and/or key in response to the user applying a sufficient pressing force to the touch screen.

With reference to FIGS. 1A-1C, in another embodiment, the touch sensing circuitry of the user interface device may detect an appendage of the user on the touch surface and, upon detecting movement thereof, notify the control circuitry. In response, the control circuitry (e.g., the frictional controller) may instruct the lateral vibration actuators to generate, adjust or modulate a friction force of/on the touch surface in a region that is localized to that appendage that urges or forces the appendage back to the original location or region of the touch surface (i.e., the location or region prior to the appendage movement). In this way, the user may experience a sensation that the touch surface includes a depression or a “potential well” (see, e.g., U.S. Pat. No. 8,525,778)—notwithstanding the fact that the touch surface may be planar or flat. In this embodiment, however, when the pressing force meets or exceeds a threshold, the control circuitry (e.g., the friction controller) adjusts or modulates the friction force of/on the touch surface in a region that is localized to the appendage (i.e., the appendage that generated or provided the pressing force) and the lateral vibration actuators generate lateral vibration of the touch surface This generates the lateral force which is applied to the particular appendage thereby providing the user a sensation of pressing, engaging and/or clicking a button, switch and/or key having a concave shape. As such, in response to the user applying a sufficient pressing force to the touch surface, the user, via the particular appendage, is provided a sensation of pushing on the top of the button, switch and/or key and feeling the predefined sensation, for example, of a click, snap and/or clack of a concave button, switch and/or key.

With reference to FIGS. 1D and 1E, in one embodiment, the user interface device includes a touch surface 101, lateral vibration actuators 104, normal force sensor 105, and control circuitry (e.g., friction controller 103 and processing or controller circuitry). The touch surface 101 may be made of a variety of materials, including, for example, an anodized aluminum plate and a glass sheet. In addition, the touch surface 101 may be placed over a display 102 and would preferably incorporate touch location sensing capabilities using any of a number of techniques known in the art (e.g., mutual capacitance, self-capacitance, acoustic pulse, etc.). The touch surface also includes friction generating actuators 103 (e.g., transparent actuators) patterned in such a manner that friction (to the movement of an appendage of a user) may be controllably modified, adjusted or modulated (e.g., increased and/or decreased) at individual locations or portions of the touch surface (i.e., at the particular location(s) of individual fingers of the user).

In this embodiment, electroadhesion is used to increase friction compared to the native friction of the touch surface. (see, e.g., U.S. Pat. No. 9,122,325). With continued reference to FIGS. 1D and 1E, in this embodiment, the user interface device includes a plurality of piezoelectric strips (two are illustrated) to serve as the lateral vibration actuators 104, although other arrangements of piezoelectric actuators as well as other types of actuators 104 (e.g., electromagnetic, magnetostrictive, electrostatic, etc.) may be employed in the present inventions. In this embodiment, the piezoelectric actuators place the touch surface into a longitudinal resonance, generating large-amplitude in-plane (lateral) motion with very little out-of-plane motion. Other techniques for generating large in-plane motions, such as phased-array focusing, may also be implemented in the present inventions.

In this embodiment, a current controller is employed to turn on and off the electroadhesion effect, although other structures and/or techniques, such as voltage control, may be used. A strain gauge based force sensor is used as the normal force sensor 105 to monitor pressing force (although other force and/or pressure sensing techniques (e.g. piezoresistive, capacitive, piezoelectric, etc.) may be used). In one embodiment, the user interface device does not include a pressing force sensor; rather, in this embodiment, a pressing force may be inferred from other measurements, such as fingertip contact area.

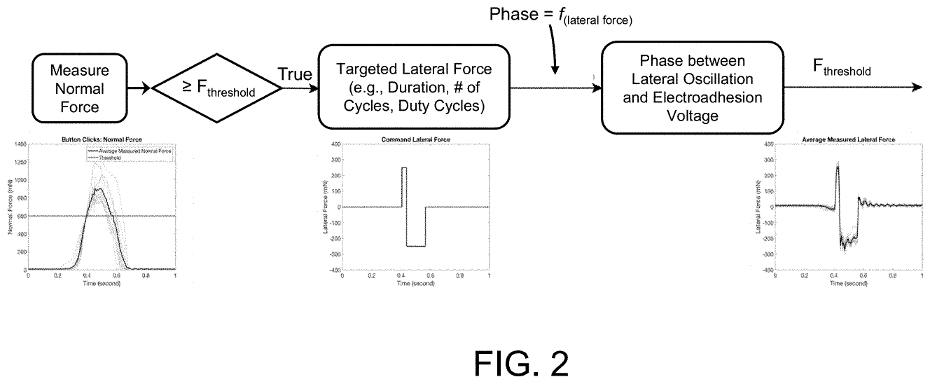

With continued reference to FIGS. 1D and 1E and with reference to FIG. 2, user interface device 101 operates as depicted in flow-like block diagram of a method of operation. The lateral vibration actuators 104 are used to force the touch surface into lateral vibrations, preferably at an ultrasonic frequency (so that they are silent) and at a peak surface speed of, for example, 0.5 meters per second. The normal force applied to the touch surface 101 is monitored with sensors 105. When either the force, the rate of change of force, or some combination thereof meets or exceeds a threshold value, the user interface device initiates processes to generate, output and/or provide localized click, snap and/or clack feedback on a localized portion of the touch surface to an appendage associated therewith. In one embodiment, the click sensation originates with a pattern of lateral forces being applied to the tip of the appendage engaging or disposed on the touch surface. In this regard, when the friction is modulated and synchronized with the lateral vibrations, lateral forces may be generated, output or provided to the appendage of the user (e.g., the tip of the appendage).

Briefly, electroadhesion is an effect whereby the friction between a fingertip (or other body part) and a surface is increased by the creation of an electric field at the skin-surface interface. To generate a lateral force, the increased friction is synchronized with the lateral vibrations. For instance, if the surface is vibrating in a left-right direction, and it is desirable to apply a force to the right, then the friction is increased (via electroadhesion) when the surface is moving to the right, and decreased (by turning off electroadhesion) when the surface is moving to the left. On average, a higher frictional force will act to the right than to the left. More generally, by controlling the phase relationship between the friction and the lateral vibrations, the direction and strength of the average force can be controlled. Additionally, if the surface moves in-plane along more than one axis (e.g., east-west as well as north-south), then the angular direction of the resulting force may also be controlled. In one embodiment, a click, snap and/or clack feedback or sensation is output to the appendage by applying one or more successive pulses in opposite directions (although a single pulse in one direction as a longer train of pulses may be employed).

Notably, the present inventions may or may not control a vector direction of the in-plane force. For example, in certain embodiments, it may be unnecessary to control the vector direction of the in-plane force because the click, snap and/or clack sensation may be produced without control of the vector direction of such force. That is, generation of the vibration of the touch surface along at least one axis may be sufficient to generate and apply a click, snap and/or clack sensation to an appendage of the user via a single axis transient, click-like force.

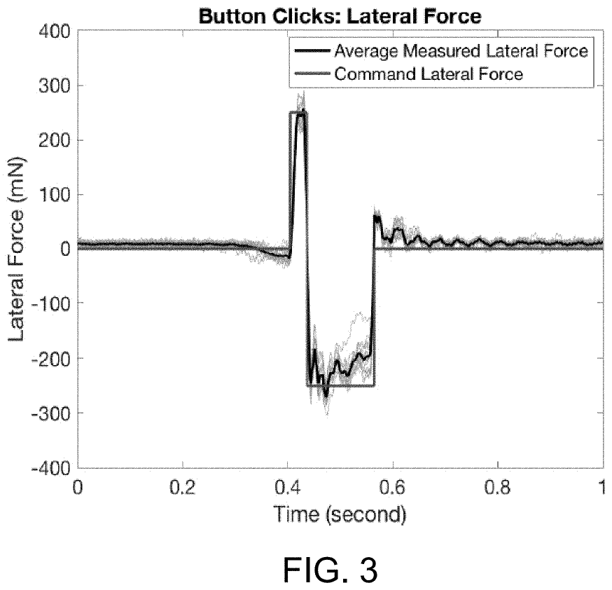

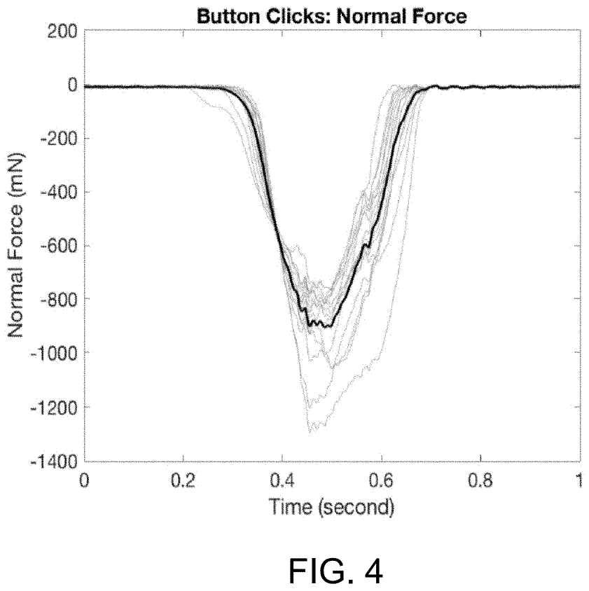

FIGS. 3 and 4 provides results of several experiments that were conducted with a user interface device generally set forth in FIG. 1D to determine the efficacy of the above-described device and method of creating localized click sensations on touch surfaces (e.g., touch screens). In a first experiment, ten subjects (20 to 30 years of age, one left-handed, four female) participated.

Briefly, each stimulus consisted of one cycle of a square waveform. The parameters of duty cycle and duration of the stimulus were adjusted to generate different button clicks as seen in the example forces shown in FIGS. 3 and 4. The duty cycle, defined as ratio of the positive-going pulse to overall pulse duration, was set to one of three levels: 5%, 25%, or 50%. The overall duration was set to one of 26 levels, ranging from 1 millisecond to 251 milliseconds with equal intervals between levels.

There were six blocks in the first experiment. Each block employed a duty cycle from one the three levels (5%, 25%, or 50%), and swept through the duration levels along either an increasing or decreasing trajectory. The increasing trajectory meant that the duration started with the minimum value (1 millisecond) and increased to the maximum value (251 milliseconds) across 26 successive stimuli. The decreasing trajectory was the reverse. Thus, each stimulus with the same duration and duty cycle was presented twice, once in each sweep direction. Each block took around 5 minutes, and the total experiment lasted 30-40 minutes, including breaks.

During each block, subjects were asked to press on the surface with the index finger of their dominant hand, as if pressing on a physical button. They were further instructed to consistently press on the same contact patch area of the surface with a constant contact angle between the finger and the surface. Headphones playing pink noise were worn to cancel any sounds produced by the experimental platform. A yellow LED indicated whether the subject reached the normal force threshold of the button click.

After each trial in the first experiment, subjects were asked whether the stimulus felt like an acceptable button click, and gave YES or NO verbal answers that were recorded by the experimenter. Subjects made their judgment based on their own prior experience with buttons.

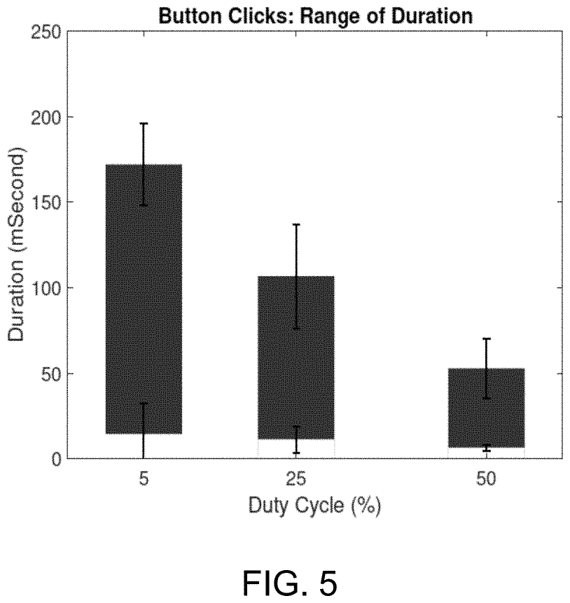

FIG. 5 shows the results of the first experiment, which depicts the range of stimulus durations that are judged to be acceptable button clicks. For the 5% duty cycle, the good-button range of the duration is 14.4+/−14.4 milliseconds to 172.1+/−24.18 milliseconds. For the 25% duty cycle, the good-button range of the duration is from 11.3+/−7.7 milliseconds to 106.8+/−30.4 milliseconds. For the 50% duty cycle, the good-button range of the duration is from 6.5+/−1.6 milliseconds to 52.8+/−17.45 milliseconds.

Based on the results of the first experiment, subjects clearly preferred a short stimulus at a large duty cycle. In addition, some subjects reported that they perceived an oscillation rather than a click when the stimulus had a long duration at the 50% duty cycle. It is possible that the quality of button click rendering is related to the number of events perceived in the stimulus, and that the detection of only one event is judged to be an acceptable button click.

Certain embodiments of the technique described and/or illustrated herein, employs very small amplitude in-plane vibrations of the touch surface, together with selective localized modulation and/or adjustment of the friction force, the technique may be applied on many different types of touch surface substrates including those made of different materials (e.g., metal, glass, ceramic, plastic, wood) and those having different shapes (e.g., planar, flat and/or curved). In each instance, the user interface device may generate and output in-plane vibrations and localized control of friction. As indicated above, the force applied to the touch surface may also be monitored and/or measured in many ways (and using many different types of structures/components) including by monitoring the size of the finger pad as the appendage presses against the touch surface.

As intimated above, the type of sensation of the click, snap and/or clack is not be limited thereto—but may be any force-based sensation. Moreover, the intensity of the click, snap and/or clack feedback may be programmable in that a first intensity of the click, snap and/or clack may be output by the user interface device to the appendage of the user corresponding to a first amount of normal force applied by the appendage to the touch surface (a measured force/pressure that meets or exceeds a first threshold) and second intensity of the click, snap and/or clack may be output by the user interface device to the appendage of the user corresponding to a second amount of normal force applied by the appendage to the touch surface (a measured force/pressure that meets or exceeds a second threshold—wherein the second threshold is greater than the first threshold). In addition thereto, or in lieu thereof, the particular type of sensation (a snap versus a click—as opposed to the intensity of the same sensation (i.e., different intensities of a click) may be depend on the normal force applied by the appendage to the touch surface.

As discussed above, the click sensation or other sensation may also be coupled with an audible and/or graphical event, such as an image or color of a button being pressed and/or the sound of a button clicking or clacking.

Significantly, the effect described here could be combined with other surface haptic effects. For instance, friction modulation as a function of either the finger's position or time (or both) could be used to give a programmable control (such as a button) a distinct texture, allowing it to be identified by touch, while the effect described here could be used to implement a click sensation when the button is actually pushed.

There are many inventions described and illustrated herein. While certain embodiments, features, attributes and advantages of the inventions have been described and illustrated, it should be understood that many others, as well as different and/or similar embodiments, features, attributes and advantages of the present inventions, are apparent from the description and illustrations. As such, the embodiments, features, attributes and advantages of the inventions described and illustrated herein are not exhaustive and it should be understood that such other, similar, as well as different, embodiments, features, attributes and advantages of the present inventions are within the scope of the present inventions.

Indeed, the present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof.

It will be appreciated that the device and methods described above in accordance with the present disclosure may be provided in various configurations. Any variety of suitable materials of construction, configurations, shapes and sizes for the components and methods of connecting the components may be utilized to meet the particular needs and requirements of an end user. It will be apparent to those skilled in the art that various modifications can be made in the design and construction of such devices without departing from the scope or spirit of the claimed subject matter, and that the claims are not limited to the preferred embodiments illustrated herein.

It is to be understood that the above description is intended to be illustrative, and not restrictive. For example, the above-described examples or embodiments (and/or aspects thereof) may be used individually or in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are intended as examples. Many other embodiments will be apparent to one of ordinary skill in the art upon reviewing the above description. The scope of the one or more embodiments of the subject matter described herein should, therefore, be determined with reference to the appended claims, along with the full scope of equivalents to which such claims are entitled. In the appended claims, terms such as “including” and “having” are used as the plain-English equivalents of the respective terms “comprising” and “wherein.”

Moreover, in the following claims, use of terms such as “first,” “second,” and “third,” etc. may be used merely as labels, and are not intended to impose numerical requirements on their objects. Further, the limitations of the following claims are not written in means-plus-function or step-plus-function format. It is applicant's intention that none of the limitations be interpreted pursuant to 35 USC § 112, ¶6 or § 112(f), unless such claim limitations expressly use the phrase “means for” or “step for” followed by a statement of function and void of any specific structure.

This written description uses examples to disclose several embodiments of the inventive subject matter, and also to enable a person of ordinary skill in the art to practice the embodiments disclosed herein, including making and using any devices or systems and performing any incorporated methods. The patentable scope of the subject matter may be defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The terms “a” and “an” herein do not denote a limitation of quantity, but rather denote the presence of at least one of the referenced item—and should be understood as not excluding a plurality, unless such exclusion is explicitly stated. The terms “first,” “second,” and the like, herein do not denote any order, quantity, or importance, but rather are used to distinguish one element from another. Furthermore, references to one example of embodiment of the presently described inventive subject matter are not intended to be interpreted as excluding the existence of additional examples or embodiments that also incorporate the recited features. The terms “comprises,” “comprising,” “includes,” “including,” “have,” and “having” or any other variation thereof, are intended to cover a non-exclusive inclusion, such that a process, method, circuit, article, integrated circuit or apparatus that includes/comprises a list of elements, components, steps (etc.) does not include only those elements, components, steps (etc.) but may include other elements, components, steps (etc.) not expressly listed or inherent to such process, method, circuit, article, integrated circuit or apparatus. Further, the terms “connect”, “connected”, “connecting” or “connection” throughout this application should be broadly interpreted to include direct or indirect (e.g., via one or more conductors and/or intermediate devices/elements (active or passive) and/or via inductive or capacitive coupling)) unless intended otherwise (e.g., use of the terms “directly connect” or “directly connected”).

Notably, reference herein to “one embodiment” or “an embodiment” (or the like) means that a particular feature, structure, or characteristic described in connection with the embodiment may be included, employed and/or incorporated in one, some or all of the embodiments of the present inventions. The usages or appearances of the phrase “in one embodiment” or “in another embodiment” (or the like) in the specification are not referring to the same embodiment, nor are separate or alternative embodiments necessarily mutually exclusive of one or more other embodiments, nor limited to a single exclusive embodiment. The same applies to the term “implementation.” The present inventions are neither limited to any single aspect nor embodiment thereof, nor to any combinations and/or permutations of such aspects and/or embodiments. Moreover, each of the aspects of the present inventions, and/or embodiments thereof, may be employed alone or in combination with one or more of the other aspects of the present inventions and/or embodiments thereof. For the sake of brevity, certain permutations and combinations are not discussed and/or illustrated separately herein.

Further, as noted above, an embodiment or implementation described herein as “exemplary” is not to be construed as ideal, preferred or advantageous, for example, over other embodiments or implementations; rather, it is intended convey or indicate the embodiment or embodiments are example embodiment(s). In the claims, the term “button” means button, switch and/or key (individually and collectively in any combination). Moreover, in the claims, the term “click” means any force-based sensation including click, snap and/or clack.

Although the present inventions have been described in certain specific aspects, many additional modifications and variations would be apparent to those skilled in the art. It is therefore to be understood that the present inventions may be practiced otherwise than specifically described without departing from the scope and spirit of the present inventions. Thus, embodiments of the present inventions should be considered in all respects as illustrative/exemplary and not restrictive.

What is claimed is:

1. A device for implementing a button click sensation on a touch surface without visually, audibly, or tactilely apparent motion of the surface, the device comprising:
a touch surface;
a lateral vibration actuator configured to produce lateral vibrations of the touch surface;
a friction controller configured to modulate a friction force between the touch surface and a plurality of appendages of a user when in contact with the touch surface, wherein the friction force is localized to the plurality of appendages;
a touch sensing device configured to measure a location of the plurality of appendages on the touch surface; and
a control device configured to synchronize the friction force between the touch surface and at least one appendage of the plurality of appendages to the lateral vibrations produced by the lateral vibration actuator such that an average force on the at least one appendage is produced and the direction of the average force is controlled;
wherein the control device is further configured to apply a lateral force to the at least one appendage to emulate the sensation of a button click when the at least one appendage applies a pressing force to the touch surface that exceeds a threshold level.

2. The device of claim 1, further comprising a normal force sensor configured to measure the pressing force applied by the at least one appendage to the touch surface.

3. The device of claim 1, wherein the control device is further configured to determine a rate of change of the pressing force applied by the at least one appendage, wherein the control device is further configured to apply a lateral force to the at least one appendage to emulate the sensation of a button click when the rate of change of the pressing force exceeds a threshold value.

4. The device of claim 1, further comprising a display, wherein the touch surface is disposed on top of the display.

5. The device of claim 1, wherein the lateral vibration actuator comprises a plurality of piezoelectric actuators.

6. The device of claim 1, wherein the lateral vibration actuator is transparent.

7. The device of claim 1, wherein the lateral vibration actuator vibrates the touch surface at an ultrasonic frequency and at a peak touch surface speed of 0.5 meters per second.

8. The device of claim 1, wherein the lateral vibration actuator is configured to produce lateral vibrations of the touch surface along multiple axes.

9. The device of claim 1, wherein the friction controller configured to modulate a friction force between the touch surface and the at least one appendage of a user by generating at least one pulse.

10. The device of claim 1, wherein the at least one pulse comprises at least one positive-going pulse having a first duration and at least one negative-going pulse having a second duration, wherein an overall duration is calculated by adding the first duration and the second duration together, wherein a duty cycle is defined as a ratio of the first duration of the positive-going pulse to the overall duration, wherein the duty cycle is 25% or greater.

11. A method for implementing a button click sensation on a touch surface without visually, audibly, or tactilely apparent motion of the surface, the method comprising:
producing lateral vibrations to a touch surface;
modulating a friction force between the touch surface and a plurality of appendages of a user when the plurality of appendages is in contact with the touch surface, wherein the friction force is localized to the plurality of appendages;
measuring a location of the plurality of appendages on the touch surface;
synchronizing the friction force between the touch surface and at least one appendage of the plurality of appendages to the lateral vibrations produced by the lateral vibration actuator such that an average force on the at least one appendage is produced and the direction of the average force is controlled; and
applying a lateral force to the at least one appendage to emulate the sensation of a button click when the at least one appendage applies a pressing force to the touch surface that exceeds a threshold level.

12. The method of claim 11, further comprising measuring the pressing force applied by the at least one appendage to the touch surface.

13. The method of claim 11, wherein applying a lateral force to the at least one appendage further comprises applying a lateral force to the at least one appendage to emulate the sensation of a button click when a rate of change of the pressing force exceeds a threshold value.

14. The method of claim 11, wherein producing lateral vibrations to a touch surface further comprises using a plurality of piezoelectric actuators to produce the lateral vibrations.

15. The method of claim 14, wherein the piezoelectric actuators are transparent.

16. The method of claim 11, wherein the lateral vibrations produced to the touch surface are at an ultrasonic frequency and at a peak touch surface speed of 0.5 meters per second.

17. The method of claim 11, wherein the lateral vibrations produced to the touch surface are along multiple axes.

18. The method of claim 11, wherein modulating a friction force between the touch surface and the at least one appendage of a user further comprises generating at least one pulse.

19. The method of claim 18, wherein the at least one pulse comprises at least one positive-going pulse having a first duration and at least one negative-going pulse having a second duration, wherein an overall duration is calculated by adding the first duration and the second duration together, wherein a duty cycle is defined as a ratio of the first duration of the positive-going pulse to the overall duration, wherein the duty cycle is 25% or greater.

20. The method of claim 19, wherein the duty cycle is 50% or greater.
